(19) United States
(12) Patent Application Publication
(10) Pub. No.: US 2014/0009552 A1
(43) Pub. Date: Jan. 9, 2014

(54) METHOD AND APPARATUS FOR PRINTING A VARIABLE DATA BARCODE

(71) Applicants: Xiaowei Liu, Beijing (CN); Zhihong Liu, Beijing (CN)

(72) Inventors: Xiaowei Liu, Beijing (CN); Zhihong Liu, Beijing (CN)

(73) Assignee: PEKING UNIVERSITY FOUNDER GROUP CO., LTD., Beijing (CN)

(21) Appl. No.: 13/882,474

(22) PCT Filed: Oct. 27, 2011
(86) PCT No.: PCT/CN11/81417

§ 371 Date: Sep. 26, 2013

(30) Foreign Application Priority Data
Oct. 29, 2010 (CN) 201010531977.8

(51) Int. Cl. B41J 3/01

(52) U.S. Cl. CPC B41J 3/01
USPC 347/107

(57) ABSTRACT

This application discloses a method and an apparatus for printing a variable data barcode. The method may include a step of printing a variable data barcode corresponding to a first barcode on a medium by an inkjet printing device (S10), a step of transferring the medium via a transmission means to a detecting region (S20), a step of scanning the variable data barcode on the medium in the detecting region to obtain a second barcode by an online detecting device (S30), and a step of comparing the first barcode to the second barcode. If they do not match, an alarm may be issued (S40). The present application can improve the printing pass rate of variable data barcodes.

### TECHNICAL FIELD

The present application relates to the field of printing, in particular, to a method and an apparatus for printing a barcode with variable data (hereinafter, variable data barcode).

### BACKGROUND

Inkjet digital printing technology has been rapidly developing in recent years. An inkjet digital printing system processes data directly and then prints with inkjets. A variable data code can be easily and readily printed. Therefore, the inkjet digital printing has advantages and speed which the traditional printing cannot match. Variable barcode code printing, which prints a unique barcode on each product, is a prominent application of the technology (such as an electronic monitoring code on a packaging box of food and drug).

Variable barcode code printing demands high quality and integrity of the variable data barcode: 1) each qualified product must be printed with a barcode; 2) the barcode printed on each qualified product must be the required barcode; 3) the barcode printed on each qualified product must be unique and cannot be the same as the other barcodes on other products.

The quality of the printed barcode is usually checked after the variable data barcode is printed in the prior art. Since the error detection is not a real-time process in the prior art, printing errors often cannot be prevented in time and thus a large number of defective products may be produced.

### SUMMARY

The present application provides a method and an apparatus for printing a variable data barcode, which may solve the above mentioned error detection problem in variable data barcode printing.

According to one embodiment of the present application, a method for printing a variable data barcode is provided. The method may include a step of printing a variable data barcode corresponding to a first barcode on a medium (such as paper) by an inkjet printing device, a step of transferring the medium via a transmission means to a detecting region, a step of scanning the variable data barcode on the medium in the detecting region to obtain a second barcode by an online detecting device, and a step of comparing the first barcode with the second barcode. If the first barcode does not match the second barcode, the method may further include a step of issuing an alarm.

According to another embodiment of the present application, an apparatus for printing a variable data barcode is provided. The apparatus may include an inkjet printing device configured to print a variable data barcode corresponding to a first barcode on a medium. Furthermore, the apparatus may include a transmission device configured to transfer the medium to a detecting region. Additionally, the apparatus may include an online detecting device configured to scan the variable data barcode on the medium in the detecting region to obtain a second barcode and a first determining module configured to compare the first barcode to the second barcode. If the first barcode does not match the second barcode, the first determining module may issue an alarm.

The method and the apparatus for printing a variable data barcode according to the embodiments of the present applicant may use an online detecting device to detect the variable data barcode online so as to address the issue with regard to the higher defective printing rate in the prior art and thus improve the printing pass rate of the variable data barcode.

### BRIEF DESCRIPTION OF THE DRAWING

The drawings described herein are used to provide a further understanding to the present application and constitute a part of this specification. Exemplary embodiments of the present application and their descriptions serve to explain the present application and do not constitute improper limitation on the present application. In the drawings:

FIG. 1 is a flowchart illustrating a method for printing a variable data barcode according to an embodiment of the present application;

FIG. 2 is a schematic diagram of a database according to an embodiment of the present application;

FIG. 3 is a flowchart illustrating a method for printing a variable data barcode according to an embodiment of the present application;

FIG. 4 is a diagram illustrating an apparatus for printing a variable data barcode according to an embodiment of the present application; and

FIG. 5 is a schematic diagram illustrating an apparatus for printing a variable data barcode according to an embodiment of the present application.

### DETAILED DESCRIPTION

Hereinafter, the present application will be explained in detail with reference to the accompanying drawings in connection with the embodiments.

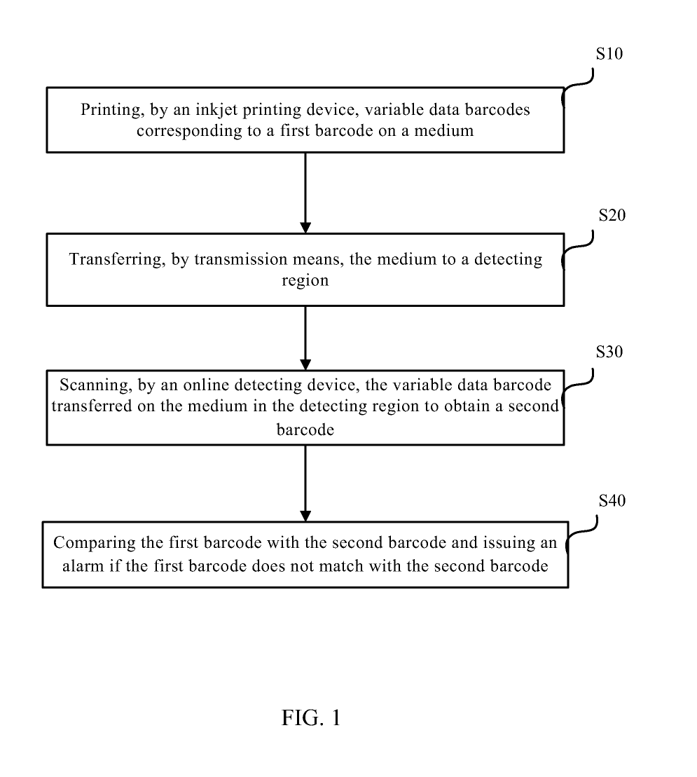

FIG. 1 is a flowchart illustrating a method for printing a variable data barcode according to an embodiment of the present application. The method may comprise:

step S10, in which an inkjet printing device operates to print a variable data barcode corresponding to a first barcode on a medium;

step S20, in which the medium is transferred by a transmission means to a detecting region;

step S30, in which an online detecting device scans the variable data barcode on the medium transferred into the detecting region to obtain a second barcode; and

step S40, in which the first barcode is compared to the second barcode, and an alarm may be issued if they do not match.

The printing method may use the online detecting device to detect the variable data barcode online to avoid high defective printing rate in the prior art due to non-real-time error detection, and thus obtain a high accuracy for printing a variable data barcode. In addition, in the conventional error detecting process, the printing apparatus may shut down when it detects a defective print product, which may reduce production efficiency. But according to the embodiments of the present application, the apparatus may issue an alarm rather than directly shutting down when it detects a defective print product, and thus the production efficiency may be improved.

The method for printing a variable data barcode may further comprise at least one of the following steps:

a step of determining whether the number of second barcodes is less than a preset value, and if so, issuing an alarm that there is a vacant barcode among the printed variable data barcodes;

a step of determining whether the second barcode is in a first database, and if not, issuing an alarm that there is an error barcode among the printed variable data barcodes, wherein the first database stores all the first barcode required to be printed; and

a step of determining whether the second barcode is in a second database, and if so, issuing an alarm that there is a repeated barcode among the printed variable data barcodes and displaying identifications of the two media with the repeated barcode when issuing the alarm, wherein the second database stores all the printed first barcodes.

The first database and the second database may be provided in one or more embodiments consistent with the present disclosure. The first database may be arranged to store all the barcodes required to be printed. When the detected second barcode is not found in the first database, the second barcode is apparently an error barcode. The second database may be arranged to store all the historical barcodes that have been printed. When the detected second barcode is found in the second database, the second barcode is apparently a repeated barcode.

Additionally, there are usually a fixed number of barcodes (for example, three variable data barcodes should be printed on each medium). A user can determine whether there is a vacant barcode by determining whether the number of the second barcodes has reached the fixed number, e.g., 3.

The vacant barcodes, repeated barcodes, and error barcodes should be corrected. In one embodiment, the defective printing product can be detected in time by detecting these three situations. The online detecting device may detect immediately the quality of the barcode after the inkjet printing. If the printed barcode falls into the three error categories (vacant, repeated, and error barcodes), the apparatus may set an alarm immediately to inform the printing factory to respond promptly. In addition, in order to maintain the efficiency in the printing factories, the apparatus may not shut down immediately in the specific process.

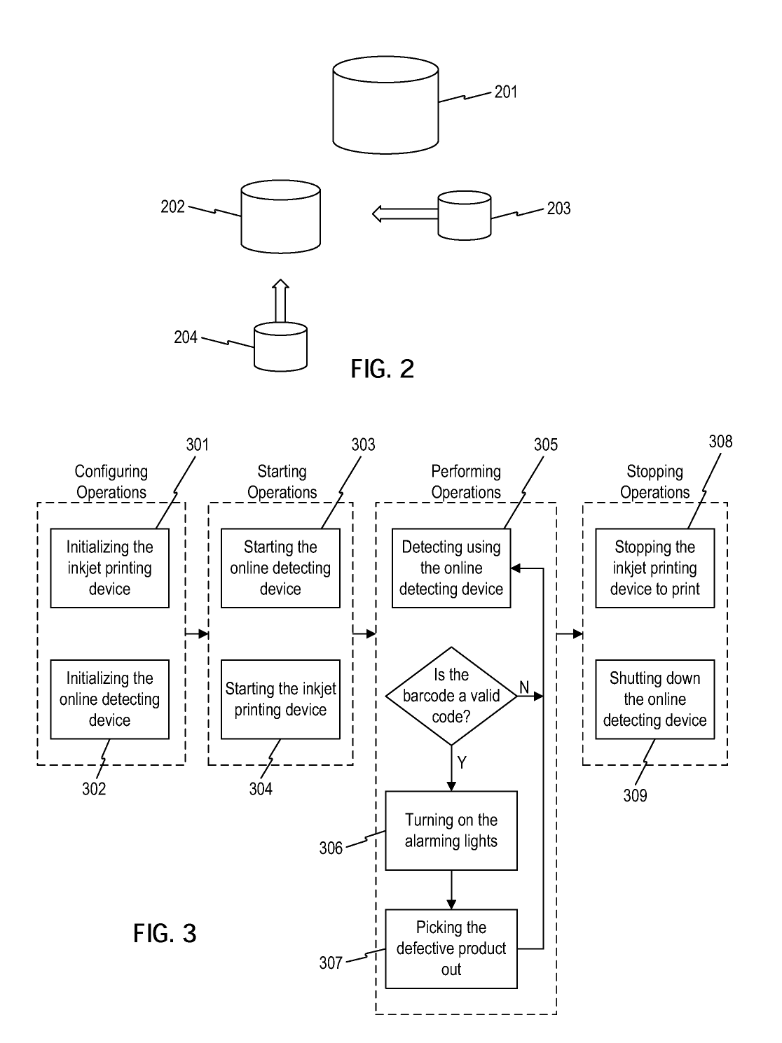

FIG. 2 is a schematic diagram of a database according to an embodiment of the present application. As shown, a database 201 may store all the barcodes required to be printed on the products, e.g., the first database, the online detecting device, and the inkjet printing device may all use database 201. Data 203 may be a first barcode which is printed on the closest product (medium) by the inkjet printing device. Data 204 may be a second barcode on the latest product (medium) which is scanned by the online detecting device. A database 202 may store all the historical data scanned by the online detecting device and saved in the online detecting device, e.g., the second database.

A method consistent with the present disclosure may include a step in which the online detecting device may obtain the first barcode via Ethernet from the inkjet printing device. The Ethernet has been widely used for data transmission by connecting various switches and network cables, or wireless device, etc. Therefore, the embodiment consistent with the present disclosure can be implemented easily and economically.

A method consistent with the present disclosure may further include a step of detecting whether the medium enters a detecting region via a first photoelectric switch, and if so, the online detecting device scanning the variable data barcode on the medium to obtain the second barcode. The method may further include a step of detecting whether the medium leaves the detecting region via a second photoelectric switch, and if so, the step of scanning would stop. Whether the medium is in the appropriate detecting region can be determined by using the photoelectric switches. As a result, the online detecting device may be correctly triggered to scan the variable data barcodes so as to avoid missed and false detection.

A method consistent with the present disclosure may further include a step of displaying the identification of the medium when an alarm is issued. If a vacant barcode, a repeated barcode or an error barcode is detected, the identifications (such as page number) of the products corresponding to these defective barcodes may be displayed. As such, the defective product can be easily picked out according to these identifications, without reducing the production efficiency.

FIG. 3 is a flowchart illustrating a method for printing a variable data barcode according to an embodiment of the present application. The method may comprise four steps: configuring operations, starting operations, performing operations, and stopping operations.

The configuring operations stage may include two steps: step 301 of initializing the inkjet printing device and step 302 of initializing the online detecting device.

In step 301, the barcodes (they may be text data txt, but also may be data in other formats) required to be printed may be loaded into a control software of the inkjet printing device before printing. In order to ensure the integrity of the barcodes, the control software may check whether there is a repeated barcode in the loaded barcodes, and if yes, the loading process may be immediately stopped and an alarm may be issued. If there is no repeated barcode in the loaded barcodes, a unique identification (page number) may be generated for the barcode on each product for the online detecting device to use.

In step 302, which may be performed after step 301, the online detecting device may be initialized. In step 302, the online detecting device and the inkjet printing device may communicate with each other via Ethernet. Both the number of used spray heads for printing and the number of the barcodes printed by each spray head may be known, and thus a configuration of the required online detecting device (for example, an industrial barcode scanning gun implemented as the online detecting device, and the number of the industrial barcode scanning gun needed) and the number of the barcodes to be scanned by each scanning gun can be determined accordingly. And then the information may be configured into the corresponding industrial barcode scanning gun.

Meanwhile, the online detecting device may receive the identification (page number) corresponding to each variable barcode via Ethernet, and then use this information to configure the control software of the online detecting device so that a defective printing product would be picked out when an alarm is issued.

The starting operations stage may comprise two steps: a step 303 of starting the online detecting device and a step 304 of starting the inkjet printing device.

After the above mentioned configuring operations step is done, the starting operations stage may begin. In step 303, the online detecting device may be activated first, and the starting process may be controlled by the control software of the inkjet printing device. Meanwhile, green segments of the alarm lights in an alarm device may be turned on to indicate that the online detecting device is operating.

In step 304, the inkjet printing device may start to print the barcodes after step 303 is completed.

The sequence of the two steps 303 and 304 can be coordinated by the control software. Otherwise, the barcodes may be printed while the online detecting device is not activated, resulting in the printed barcodes not being verified in time, and thus may cause potential quality issues for the final products.

The performing operations stage may comprise three parts: a step 305 of detecting the online detecting device, a step 306 of setting the alarming lights and a step 307 of picking the defective product out.

The performing operations stage may begin after the operation starting stage is done. The inkjet printing device may start to print the barcodes, while the online detecting device may start to detect printed barcodes. During the detecting process, the online detecting device may obtain the scanned barcode from the industrial barcode scanning gun in real time and may also obtain the printed barcode from the inkjet printing device in real time. Then the online detecting device may compare the scanned barcode with the printed barcode. If there is any vacant barcode, error barcode, or repeated barcode, the device may issue an alarm via lights and/or buzzers.

Meanwhile, the online detecting device may also display the identification (page number) corresponding to the current defective product. As long as one barcode on the product can be correctly detected, the identification (page number) of the product can be determined. Therefore, a vacant, error or repeated barcode on the product may be used to determine the identification of the defective product. The online detecting device may then display the identification. Furthermore, for a repeated barcode, the identification (page number) of the medium where the repeated barcode is detected for the first time can be displayed.

If there is no barcode on the product (medium) or all the barcodes on the product cannot be correctly detected, there may be a vacant barcode on the product (medium) and the identification (page number) of the product may be marked as “N+M”, where N is the identification (page number) for the closest product of the all identified products, M is the number of times that the barcode cannot be correctly detected (i.e. continuous M products that cannot be correctly detected after a product is correctly detected). M increases from 0 sequentially. Once the identification of the product can be correctly detected, the value of M may be cleared.

Because each product has a unique identification it is very easy to detect a defective product using this method. Furthermore, if there is a defective product, the apparatus does not need to shut down immediately, which may ensure the production efficiency.

The stopping operation stage may include two parts: a step 308 of stopping the inkjet printing device to print the barcode and a step 309 of shutting down the online detecting device.

When all the barcodes have been printed, the printing may be stopped first and then the online detecting device may be shut down. The sequence of the two steps in this stage is in the reverse order of that of the starting operations stage.

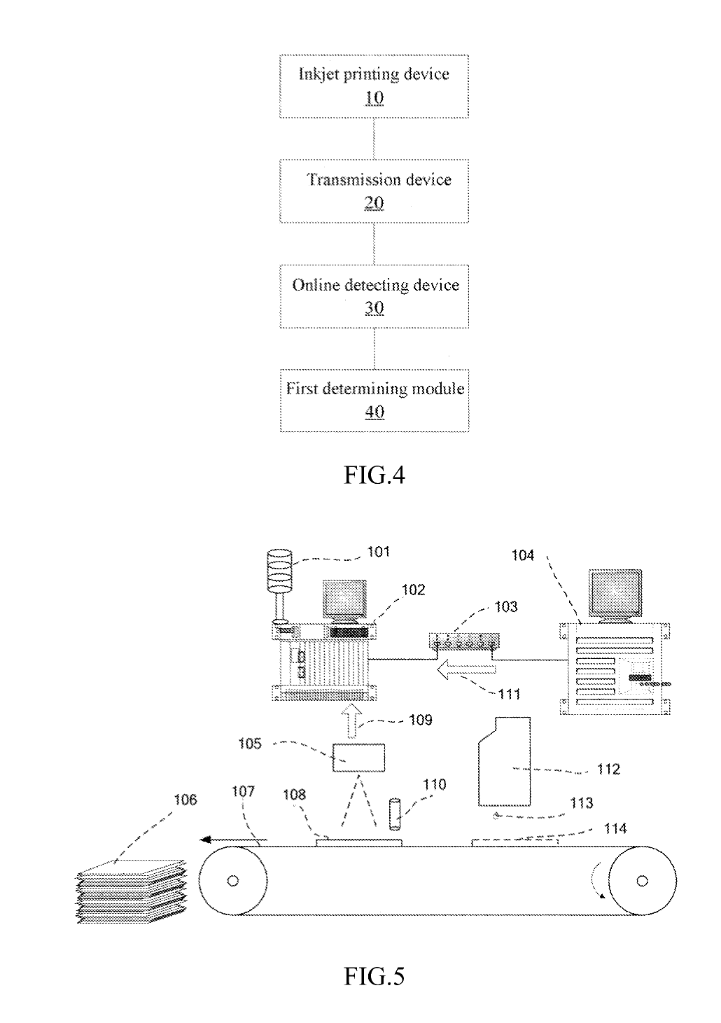

FIG. 4 is a schematic diagram illustrating an apparatus for printing a variable data barcode according to an embodiment of the present application, the apparatus may include:

an inkjet printing device 10 configured to print a variable data barcode corresponding to a first barcode on a medium;

a transmission device 20 configured to transfer the medium to a detecting region;

an online detecting device 30 configured to scan the variable data barcode on the medium in the detecting region to obtain a second barcode; and

a first determining module 40 configured to determine if the first barcode matches the second barcode, and if not, the module 40 may issue an alarm.

The online detecting device 30 of the apparatus may detect the variable data barcode online in order to reduce the defective rate due to the non-real-time error detection described in the prior art, so that the apparatus may achieve high accuracy for printing a variable data barcode.

The apparatus may further include at least one of the following modules:

a second determining module configured to determine whether or not the number of second barcodes is less than a preset value, and if so, the second determining module may issue an alarm indicating that there is a vacant barcode in the printed variable data barcodes;

a third determining module configured to determine whether or not the second barcode is in a first database, and if not, the third determining module may issue an alarm indicating that there is an error barcode in the printed variable data barcodes, wherein the first database stores all the first barcode required to be printed;

a fourth determining module configured to determine whether or not the second barcode is in a second database, and if so, the fourth determining module may issue an alarm indicating that there is a repeated barcode in the printed variable data barcodes and may display identifications of the two media with the repeated barcode when the alarm is issued, wherein the second database stores all the printed first barcodes.

The vacant, repeated and error barcodes may need to be corrected, and thus in one or more embodiments, the defective products may be detected in time by detecting these three situations.

The apparatus may further include an Ethernet configured to transfer the first barcode from the inkjet printing device to the online detecting device.

The apparatus may further include a first photoelectric switch configured to detect whether the medium has entered into the detecting region and a second photoelectric switch configured to detect whether the medium has left the detecting region. Whether the medium is in the appropriate detecting region can be determined by using the photoelectric switches. Therefore, the online detecting device can be correctly triggered to scan so as to reduce the missed and false detection.

The apparatus may further include a display configured to display the identification of the medium when an alarm has been issued. If a vacant, repeated or error barcode is detected, the identifications (such as page number) of the products with these defective barcodes may be displayed. In this regard, the defective products can be easily picked out according to these identifications in the printing factories, without reducing the production efficiency.

FIG. 5 is a schematic diagram illustrating an apparatus for printing a variable data barcode according to an embodiment of the present application. The apparatus may include an industrial alarming light (i.e., an alarming device) 101 configured to include green, red, and yellow segments and a buzzer, an online detecting device 102 configured to include: an industrial barcode scanning gun 105 and its cable 109, and a display configured to display related information, An Ethernet 103 configured to connect the inkjet printing device 104 and the online detecting device 102, the inkjet printing device 104, printed products 106, a belt (i.e., a transmission device) configured to move from right to left along with the products (medium) which are gripped via air draft, a printed product 108 located in the online detecting region, photoelectric switches 110 of the online detecting device, a spray head 112 controlled by the printing device 104, an ink-drop 113 sprayed by the spray head, products 114 located in the inkjet printing region, a barcode scanned by the industrial barcode scanning gun 105 and then transmitted to the online detecting device 102, and a barcode printed by the inkjet printing device.

As shown in FIG. 5, the medium 114 may be located on the belt 107 and may move along with the belt from right to left. When the medium 114 arrives the printing region, the spray head 112 may spray the ink-drops 113 under the control of the inkjet printing device 104, and the ink-drops may fall on the medium 114 to form the barcode. Then, the printed medium 114 may continue to move to the left to reach the detecting region. The online detecting device 102 may detect that the product enters into the detecting region via the photoelectric switches 110, and then the industrial barcode scanning gun 105 may scan the barcode and transfer the scanned data through cable 109 into the online detecting device 102. At the same time, the online detecting device 102 may obtain the printed barcode 111 from the inkjet printing device 104 via the Ethernet. When the photoelectric switches 110 detects that the medium has left the detecting region, the apparatus may consider that the scanning of the barcode is completed. Then, the apparatus may compare the printed data 111 with the scanned data in order to detect whether the quality of the barcode which is just printed is acceptable. If not, the apparatus may issue an alarm immediately via alarming lights and buzzers 101.

Through the above steps, the apparatus may check the barcode 204 (not shown in FIG. 5) obtained for each scanning. If there is a vacant or error barcode, for example, the yellow segment of the alarming light 101 may be turned on while the buzzer alarms. If there is a repeated barcode, the red segment of the alarming light may be turned on while the buzzer alarms a longer time in order to prompt users to respond promptly.

When the online detecting device detects that there is a quality problem of the barcode printing, the apparatus may issue alarms to prompt a user to respond rather than shut down immediately, which would have reduced the production efficiency.

Before the inkjet printing device 104 prints, the apparatus may generate the unique identification (page number) for the variable data barcode to be printed on each product, and the identification may increase sequentially. Then, the identification may be printed on the non-product region of the medium. Meanwhile, the identification may be transferred to the online detecting device via Ethernet 103. If a vacant, repeated or error barcode is detected, the identifications (page number) of the products with these defective barcodes would be displayed. In this regard, the defective product can be easily picked out according to these identifications in the printing factories, without reducing the production efficiency.

In addition, there is no limit on the number of industrial barcode scanning guns used according to the present invention. In order to increase the number of the scanning guns, the software can be modified to adjust the number of scanning guns in the online detecting system.

In view of the above, the printing pass rate of the variable data barcode may be increased according to the embodiments of the present invention.

It will be readily apparent to those skilled in the art that the modules or steps of the present application may be implemented with a common computing device. In addition, the modules or steps of the present application can be concentrated or run in a single computing device or distributed in a network composed of multiple computing devices. Optionally, the modules or steps may be achieved by using codes of the executable program, so that they can be stored in the storage medium, or the plurality of the modules or steps can be fabricated into an individual integrated circuit module. Therefore, the present application is not limited to any particular hardware, software or combination thereof.

The foregoing is only preferred embodiments of the present application, and it is not intended to limit the present application. Moreover, it will be apparent to those skilled in the art that various modifications and variations can be made to the present application. Thus, any modifications, equivalent substitutions, improvements, etc., within the spirit and principle of the present application should be included within the scope of protection of the application.

What is claimed is:

1. A method for printing a variable data barcode, comprising:
printing, by an inkjet printing device, variable data barcodes corresponding to a first barcode on a medium;
transferring, by transmission means, the medium to a detecting region;
scanning, by an online detecting device, the variable data barcode transferred on the medium in the detecting region to obtain a second barcode;
comparing the first barcode with the second barcode; and
issuing an alarm if the first barcode does not march with the second barcode.

2. The method according to claim 1, further comprising at least one of the following steps:
determining whether or not the number of the second barcode is less than a preset value, and issuing the alarm to indicate that there is a vacant barcode in the at least one variable data barcode if the number is less than the preset value;
determining whether or not the second barcode is in a first database, and issuing the alarm to indicate that there is an error barcode in the variable data barcodes if the second barcode is not in a first database, wherein the first database includes all the first barcodes required to print; and
determining whether or not the second barcode is in a second database, and issuing the alarm to indicate that there is a repeated barcode in the variable data barcodes and displaying identifications of the two media with the repeated barcode when alarming if the second barcode is in the second database, wherein the second database includes all the printed first barcodes.

3. The method according to claim 1, further comprising:
obtaining, by the online detecting device, the first barcode via Ethernet from the inkjet printing device.

4. The method according to claim 1, further comprising:
detecting, by a first photoelectric switch, whether or not the medium enters into the detecting region, if yes,
scanning, by the online detecting device, the variable data barcode on the medium to obtain the second barcode; and
detecting, by a second photoelectric switch, whether or not the medium leaves the detecting region, if yes, stopping the step of scanning.

5. The method according to claim 1, further comprising:
displaying the identification of the medium when alarming.

6. An apparatus for printing a variable data barcode, comprising:
an inkjet printing device configured to print a variable data barcode corresponding to a first barcode on a medium;
a transmission device configured to transfer the medium to a detecting region;
an online detecting device configured to scan the variable data barcode on the medium in the detecting region to obtain a second barcode; and
a first determining module configured to compare the first barcode with the second barcode to determine if the first barcode marches with the second barcode, if yes, the first determining module issue an alarm.

7. The apparatus according to claim 6, further comprising at least one of the following modules:
a second determining module configured to determine whether or not the number of the second barcode is less than a preset value, if yes, the second determining module issues the alarm to indicate that there is a vacant barcode in the variable data barcodes;
a third determining module configured to determine whether or not the second barcode is in a first database, if not, the third determining module issues the alarm to indicate that there is an error barcode in the variable data barcodes, wherein the first database includes all the first barcodes required to print;
a fourth determining module configured to determine whether or not the second barcode is in a second database, if yes, the fourth determining module issues the alarm to indicate that there is a repeated barcode in the variable data barcodes and displays identifications of the two media with the repeated barcode when alarms, wherein the second database includes all the printed first barcodes.

8. The apparatus according to claim 6, further comprising:
Ethernet configured to transfer the first barcode from the inkjet printing device to the online detecting device.

9. The apparatus according to claim 6, further comprising:
a first photoelectric switch configured to detect whether or not the medium enters into the detecting region; and
a second photoelectric switch configured to detects whether or not the medium leaves the detecting region.

10. The apparatus according to claim 6, further comprising:
a display configured to display the identification of the medium when alarming.
